(19) United States
(12) Patent Application Publication
(10) Pub. No.: US 2002/0106511 A1
(43) Pub. Date: Aug. 8, 2002

(54) Encapsulation of compounds in vesicles

(75) Inventor: Thomas Honger Callisen, Frederiksberg C (DK)

Correspondence Address: NOVOZYMES NORTH AMERICA, INC., 500 FIFTH AVENUE, SUITE 1600, NEW YORK, NY, 10110, US

(73) Assignee: Novozymes A/S, Bagsvaerd (DK)

(21) Appl. No.: 10/005,321

(22) Filed: Dec. 3, 2001

Related U.S. Application Data
(60) Provisional application No. 60/255,268, filed on Dec. 13, 2000.

(30) Foreign Application Priority Data
Dec. 1, 2000 (DK) PA 2000 01810

(51) Int. Cl. B32B 5/16; B32B 9/00; B32B 9/02; B32B 9/04; B32B 15/02; B32B 17/02; B32B 19/00; B32B 21/02; B32B 23/02; B32B 27/02

(52) U.S. Cl. 428/402.2

(57) ABSTRACT

Vesicles formed from synthetic polymers are used for encapsulation of compounds in order to protect the compounds from the chemical environment in which they are used.

### CROSS-REFERENCE TO RELATED APPLICATIONS

This application claims, under 35 U.S.C. 119, priority or the benefit of Danish application no. PA 2000 01810, filed Dec. 1, 2000, and U.S. provisional application No. 60/255,268, filed Dec. 13, 2000, the contents of which are fully incorporated herein by reference.

### FIELD OF THE INVENTION

The invention relates to compositions comprising compounds encapsulated in synthetic polymer based vesicles, such as detergent compositions.

### BACKGROUND

Chemical compositions that comprise fragile compounds are often modified or degraded by other reactive compounds. Accordingly, there is a need for a general means for reducing or eliminating this negative effect.

### SUMMARY

We have found that vesicles formed from synthetic polymers can be used for encapsulation of compounds in order to protect the compounds from the chemical environment in which they are used.

Accordingly, there is provided a composition comprising a surfactant and at least one compound encapsulated in a vesicle, wherein the vesicle comprises at least 50% of a synthetic polymer as a vesicle-forming agent.

In a second aspect, there is provided a composition comprising an enzyme encapsulated in a vesicle, wherein the vesicle comprises at least 50% of a synthetic polymer as a vesicle-forming agent.

In a third aspect, there is provided a method comprising the steps of:

encapsulating at least one compound in a vesicle, and

adding the vesicle to a surfactant containing composition,

wherein the vesicle comprises at least 50% of a synthetic polymer as a vesicle forming agent.

In a fourth aspect, there is provided a method for preventing a compound from reacting with other compounds, comprising encapsulating the compound in a vesicle, wherein the vesicle comprises at least 50% of a synthetic polymer as a vesicle-forming agent.

In embodiments, the compound is an enzyme.

In further aspects, enzyme-containing vesicles are used for improving the stability of the enzymes, or for preventing the enzymes from reacting with other compounds.

### DETAILED DESCRIPTION

Synthetic Polymers

Suitable synthetic polymers for forming the vesicles of the invention (vesicle-forming agents) may be combinations of synthetic polymers of the monomer-classes ethyleneoxide, propyleneoxide, ethylethylene, acrylic acid, and vinyl amine. Homopolymers of these monomers (such as polyethyleneoxide—also known as PEG—and polyethylethylene) may be covalently linked to form di- or tri-block-co-polymers. Other monomers which provide similar hydrophilic and hydrophobic characteristics of the subunits/domains, and which will generate an amphiphilic co-polymer may be used. Diblock-co-polymers self-associate as bilayer phases while tri-block-co-polymers, e.g., composed of a hydrophobic central domain connected to hydrophilic domains at each end, form single-molecular smectic layers with a hydrophobic core. Increasing the width of the interior hydrophobic core would typically bring about improved properties with respect to water permeability of the vesicular structure. The stability of the layers is balanced by the choice of subunits, which make up the co-polymers. It is possible to change the stability of the vesicles by cross-polymerization of the monomers or by incorporating tri-block-co-polymers into the bilayer structures or in general alloy the vesicle structure with minor components that modify the balance of forces in the structure. Examples of preferred polymers are EO40-EE37 (nomenclature as in Discher et al. (1999), Science, Vol. 284, pp. 1143-1146), EO40-EE74-EO40, EO50-EE37 and Pluronics (such as L121), or combinations thereof.

“Synthetic polymer” is to be understood as a polymer, which is composed of synthetic homo-polymers, such as polyethyleneoxide, polypropylenoxide, or polyethylethylene. Subunits or domains may consist of hetero-polymers of monomers rendering an overall hydrophilic or hydrophobic stretch. The term “synthetic” is to be understood as a non-naturally occurring compound.

In an embodiment, the polymers are uncharged at the pH of the composition.

In another embodiment, each homo-polymer (domain) of the block-co-polymers may consist of at least 10 monomers, preferably at least 20 monomers, more preferably at least 30 monomers, and most preferably at least 40 monomers.

In di-block-co-polymers the domains may comprise 30-50 monomers of the ethyleneoxide or propyleneoxide type; and in tri-block-co-polymers the central domain may comprise 60-100 monomers of the ethyleneoxide or propyleneoxide type with the exterior domains comprising 30-50 monomers.

In a preferred embodiment, the polymers are not amphiphilic lipids, such as phospholipids.

Vesicles

Vesicles are to be understood as uni- or multi-lamellar structures as defined in J.N. Israelachvili, Intermolecular and Surface Forces, 2nd edition (1992), Academic Press, San Diego Calif., USA.

The vesicular structure may be of:

1) a bilayer-type arrangement with two leaflets of molecular layers;

2) a single layer of molecules, or

3) combinations of 1) and 2).

The vesicles may also be part of a suspension or a multiple emulsion with a bulk water-like phase or a bulk oil-like phase. The molecular constituents would primarily be of an amphiphilic character with domains of high and low water solubility (the latter often translates into high oil solubility). Minor components may have only one of the previous types of domains. In case of 1), the main class of molecules would have two domains with oppositely preferred solvent. In case of 2) the dominant part of molecules would have three domains with the center-domain of opposite solvent-preference to the external domains. The orientation of the molecular domains depends on the solvent for the vesicles (water-like or oil-like bulk phase). The intermolecular interactions in the vesicles may be of covalent and non-covalent origin. The molecules and the molecular building blocks may be of natural or synthetic origin; classes included are lipids, sugars, amino acids, nucleic acids, and synthetic polymers of building blocks, such as ethyleneoxide, propyleneoxide, and butyleneoxide. Reactive compounds may be incorporated in the vesicle structure to generate cross-linking among the molecules.

In a preferred embodiment the vesicle is an aqueous compartment enclosed by a membrane comprising one or more layers, where the layers have an inner hydrophobic domain and an outer hydrophilic domain.

The vesicles of the invention may suitably comprise at least 50%, preferably at least 60%, more preferably at least 70%, even more preferably at least 80%, most preferably at least 90%, and in particular 95% of synthetic polymers as vesicle forming agents. In a preferred embodiment the vesicles are composed of 100% of synthetic polymers as vesicle forming agents.

The average diameter of the polymer-based vesicles are 0.1 μm to 500 μm, preferably 0.1 μm to 100 μm, more preferably 0.1 μm to 10 μm.

The vesicles may be uni-lamellar or have an onion-like structure, such as a multi-lamellar structure. Polymer-based vesicles are particularly suitable for use in surfactant solutions, as compared to lipid vesicles (liposomes), due to a better stability towards surfactants and lower water permeability. Polymer-based vesicles are also referred to as polymersomes (in contrast to liposomes).

The polymer-based vesicles may be prepared by treating a suspension of polymers and compounds (for encapsulation) with ultra-sonic irradiation, or extruding the suspension through a porous membrane (filters) of desired pore size. Ultra-sonic treatment and extrusion may be combined or exchanged by methods such as reverse phase dialysis. Subsequently, the vesicles with the entrapped compounds may be concentrated by centrifugation or dialysis.

Encapsulated Compounds

Suitable compounds for being encapsulated in the polymer-based vesicles may be fragile compounds or reactive compounds. Fragile compounds may be encapsulated in order to be separated from the surfactant and/or other reactive compounds; and reactive compounds may be encapsulated in order to be separated from other (non-reactive) compounds. The vesicles may contain more than one type of compound.

In an embodiment, the encapsulated compounds are biologically active compounds, such as polypeptides or proteins. Preferably the encapsulated compounds have a molecular weight of less than 500 kDa, more preferably less than 200 kDa, and most preferably less than 100 kDa.

In another embodiment, the encapsulated compounds have improved stability compared to non-encapsulated compounds of the same kind in the composition in which the compounds are comprised.

In a preferred embodiment, the encapsulated compounds are enzymes, such as proteases, lipases, cutinases, amylases, carbohydrases, cellulases, pectinases, mannanases, arabinases, galactanases, xylanases, oxidases, e.g., laccases, and/or peroxidases (such as haloperoxidases).

The enzymes in the context of the present invention may be any enzyme or combination of different enzymes. Accordingly, when reference is made to “an enzyme” this will in general be understood to include both a single enzyme and a combination of more than one enzyme.

It is to be understood that enzyme variants (produced, for example, by recombinant techniques) are included within the meaning of the term “enzyme”. Examples of such enzyme variants are disclosed, e.g., in EP 251446 (Genencor), WO 91/00345 (Novo Nordisk A/S), EP 525610 (Solvay) and WO 94/02618 (Gist-Brocades NV). The enzyme classification employed in the present specification and claims is in accordance with Recommendations (1992) of the Nomenclature Committee of the International Union of Biochemistry and Molecular Biology, Academic Press, Inc., 1992.

Accordingly the types of enzymes which may appropriately be incorporated in the polymer-based vesicles include oxidoreductases (EC 1.-.-.-), transferases (EC 2.-.-.-), hydrolases (EC 3.-.-.-), lyases (EC 4.-.-.-), isomerases (EC 5.-.-.-) and ligases (EC 6.-.-.-).

Preferred oxidoreductases in the context of the invention are peroxidases (EC 1.11.1), laccases (EC 1.10.3.2) and glucose oxidases (EC 1.1.3.4), while preferred transferases are transferases in any of the following sub-classes:

a) Transferases transferring one-carbon groups (EC 2.1);

b) Transferases transferring aldehyde or ketone residues (EC 2.2); acyltransferases (EC 2.3);

c) Glycosyltransferases (EC 2.4);

d) Transferases transferring alkyl or aryl groups, other than methyl groups (EC 2.5); and

e) Transferases transferring nitrogeneous groups (EC 2.6).

A most preferred type of transferase in the context of the invention is a transglutaminase (protein-glutamine ∂-glutamyltransferase; EC 2.3.2.13).

Further examples of suitable transglutaminases are described in WO 96/06931 (Novo Nordisk A/S).

Preferred hydrolases in the context of the invention are: Carboxylic ester hydrolases (EC 3.1.1.-) such as lipases (EC 3.1.1.3); phytases (EC 3.1.3.-), e.g. 3-phytases (EC 3.1.3.8) and 6-phytases (EC 3.1.3.26); glycosidases (EC 3.2, which fall within a group denoted herein as “carbohydrases”), such as Δ-amylases (EC 3.2.1.1); peptidases (EC 3.4, also known as proteases); and other carbonyl hydrolases].

In the present context, the term “carbohydrase” is used to denote not only enzymes capable of breaking down carbohydrate chains (e.g. starches) of especially five- and six-membered ring structures (i.e. glycosidases, EC 3.2), but also enzymes capable of isomerizing carbohydrates, e.g. six-membered ring structures such as D-glucose to five-membered ring structures such as D-fructose.

Carbohydrases of relevance include the following (EC numbers in parentheses): Δ-amylases (3.2.1.1), E-amylases (3.2.1.2), glucan 1,4-Δ-glucosidases (3.2.1.3), cellulases (3.2.1.4), endo-1,3(4)-E-glucanases (3.2.1.6), endo-1,4-E-xylanases (3.2.1.8), dextranases (3.2.1.11), chitinases (3.2.1.14), polygalacturonases (3.2.1.15), lysozymes (3.2.1.17), Eglucosidases (3.2.1.21), A-galactosidases (3.2.1.22), E-galactosidases (3.2.1.23), amylo-1,6-glucosidases (3.2.1.33), xylan 1,4-E-xylosidases (3.2.1.37), glucan endo-1,3-E-D-glucosidases (3.2.1.39), Δ-dextrin endo-1,6-Δ-glucosidases (3.2.1.41), sucrose Δ-glucosidases (3.2.1.48), glucan endo-1,3-Δ-glucosidases (3.2.1.59), glucan 1,4-E-glucosidases (3.2.1.74), glucan endo-1,6-E-glucosidases (3.2.1.75), arabinan endo-1,5-Δ-L-arabinosidases (3.2.1.99), lactases (3.2.1.108), chitosanases (3.2.1.132) and xylose isomerases (5.3.1.5).

Examples of commercially available oxidoreductases (EC 1.-.-.-) include Gluzyme™ (enzyme available from Novozymes A/S).

Examples of commercially available proteases (peptidases) include Kannase™, Everlase™, Esperase™, Alcalase™, Neutrase™, Durazym™, Savinase™, Pyrase™, Pancreatic Trypsin NOVO (PTN), Bio-Feed™ Pro and Clear-Lens™ Pro (all available from Novozymes A/S, Bagsvaerd, Denmark).

Other commercially available proteases include Maxatase™, Maxacal™, Maxapem™, Opticlean™ and Purafect™ (available from Genencor International Inc. or Gist-Brocades).

Examples of commercially available lipases include Lipoprime™ Lipolase™, Lipolase™ Ultra, Lipozyme™, Palatase™, Novozym™ 435 and Lecitase™ (all available from Novozymes A/S).

Other commercially available lipases include Lumafast™ (Pseudomonas mendocina lipase from Genencor International Inc.); Lipomax™ (Ps. pseudoalcaligenes lipase from Gist-Brocades/Genencor International Inc.; and Bacillus sp. lipase from Solvay enzymes. Further lipases are available from other suppliers.

Examples of commercially available carbohydrases include Alpha-Gal™, Bio-Feed™ Alpha, Bio-Feed™ Beta, Bio-Feed™ Plus, Bio-Feed™ Plus, Novozyme™ 188, Celluclast™, Cellusoft™, Ceremyl™, Citrozym™, Denimax™, Dezyme™, Dextrozyme™, Finizym™, Fungamyl™, Gamanase™, Glucanex™, Lactozym™, Maltogenase™, Pentopan™, Pectinex™, Promozyme™, Pulpzyme™, Novamy™, Termamyl™, AMG™ (Amyloglucosidase Novo), Maltogenase™, Sweetzyme™ and Aquazym™ (all available from Novozymes A/S). Further carbohydrases are available from other suppliers.

Compositions

The composition of the invention may be a surfactant containing composition, (such as a detergent composition), a cosmetic composition or a personal care composition, such as lotions (e.g. eye lotions), liquids, creams, gels, pastes, ointments (e.g. eye ointments), soaps, shampoos, conditioners, antiperspirants, deodorants, mouth wash, nasal sprays, or contact lens products.

The composition of the invention may be formulated as a solid or a liquid. When formulated as a liquid, the composition is typically an aqueous composition. When formulated as a solid, the composition is typically a powder, a granulate, a paste or a gelled product.

In a preferred embodiment, the composition of the invention is a liquid surfactant containing composition.

Surfactants

Suitable surfactants for being incorporated in the composition may be non-ionic (including semi-polar), anionic, cationic and/or zwitterionic. The surfactants are preferably anionic or non-ionic. The surfactants are typically present in the composition at a concentration of from 1% to 90% (preferably 5% to 60%, more preferably 10% to 50%) by weight, but the composition may also contain close to 100% surfactant or consist of 100% surfactant. The pH of the composition is pH 4-11, preferably pH 6-11, more preferably in the alkaline range (such as pH 7-10), and particularly pH 8-10, as determined in a 1% aqueous solution.

When included therein, the composition will usually contain from about 1% to about 80%, preferably about 2% to about 50%, and more preferably about 5% to about 40% by weight of an anionic surfactant, such as linear alkylbenzenesulfonate, alpha-olefinsulfonate, alkyl sulfate (fatty alcohol sulfate), alcohol ethoxysulfate, secondary alkanesulfonate, alpha-sulfo fatty acid methyl ester, alkyl- or alkenylsuccinic acid or soap.

When included therein, the composition will usually contain from about 1% to about 80%, preferably about 2% to about 50%, and more preferably about 5% to about 40% by weight of a non-ionic surfactant, such as alcohol ethoxylate, nonylphenol ethoxylate, alkylpolyglycoside, alkyldimethylamineoxide, ethoxylated fatty acid monoethanolamide, fatty acid monoethanolamide, polyhydroxy alkyl fatty acid amide, or N-acyl N-alkyl derivatives of glucosamine (“glucamides”).

Detergent Composition

The surfactant containing composition may be a detergent composition. As such, it may be formulated as a hand or machine laundry detergent composition including a laundry additive composition suitable for pre-treatment of stained fabrics and a rinse added fabric softener composition, or be formulated as a detergent composition for use in general household hard surface cleaning operations, or be formulated for hand or machine dishwashing operations.

In a specific aspect, the detergent composition may comprise one or more other enzymes such as a protease, a lipase, a cutinase, an amylase, a carbohydrase, a cellulase, a pectinase, a mannanase, an arabinase, a galactanase, a xylanase, an oxidase, e.g., a laccase, and/or a peroxidase.

In general the properties of the chosen enzyme(s) should be compatible with the detergent, (i.e. pH-optimum, compatibility with other enzymatic and non-enzymatic ingredients, etc.), and the enzyme(s) should be present in effective amounts.

Proteases:

Suitable proteases include those of animal, vegetable or microbial origin. Microbial origin is preferred. Chemically modified or protein engineered mutants are included. The protease may be a serine protease or a metallo protease, preferably an alkaline microbial protease or a trypsin-like protease. Examples of alkaline proteases are subtilisins, especially those derived from Bacillus, e.g., subtilisin Novo, subtilisin Carlsberg, subtilisin 309, subtilisin 147 and subtilisin 168 (described in WO 89/06279). Examples of trypsin-like proteases are trypsin (e.g. of porcine or bovine origin) and the Fusarium protease described in WO 89/06270 and WO 94/25583.

Examples of useful proteases are the variants described in WO 92/19729, WO 98/20115, WO 98/20116, and WO 98/34946, especially the variants with substitutions in one or more of the following positions: 27, 36, 57, 76, 87, 97, 101, 104, 120, 123, 167, 170,194, 206, 218, 222, 224, 235 and 274.

Preferred commercially available protease enzymes include Alcalase™, Savinase™, Primase™, Everlase™, Esperase™, and Kannase™ (Novozymes A/S), Maxatase™, Maxacal™, Maxapem™, Properase™, Purafect™, Purafect OxP™, FN2™, and FN3™ (Genencor International Inc.).

Lipases:

Suitable lipases include those of bacterial or fungal origin. Chemically modified or protein engineered mutants are included. Examples of useful lipases include lipases from Humicola (synonym Thermomyces), e.g. from H. lanuginosa (T. lanuginosus) as described in EP 258 068 and EP 305 216 or from H. insolens as described in WO 96/13580, a Pseudomonas lipase, e.g. from P. alcaligenes or P. pseudoalcaligenes (EP 218 272), P. cepacia (EP 331 376), P. stutzeri (GB 1,372,034), P. fluorescens, Pseudomonas sp. strain SD 705 (WO 95/06720 and WO 96/27002), P. wisconsinensis (WO 96/12012), a Bacillus lipase, e.g. from B. subtilis (Dartois et al. (1993), Biochemica et Biophysica Acta, 1131, 253-360), B. stearothermophilus (JP 64/744992) or B. pumilus (WO 91/16422).

Other examples are lipase variants such as those described in WO 92/05249, WO 94/01541, EP 407 225, EP 260 105, WO 95/35381, WO 96/00292, WO 95/30744, WO 94/25578, WO 95/14783, WO 95/22615, WO 97/04079 and WO 97/07202.

Preferred commercially available lipase enzymes include Lipolase□, Lipolase Ultra□ and Lipoprime□ (Novozymes A/S).

Amylases:

Suitable amylases (Δ and/or E) include those of bacterial or fungal origin. Chemically modified or protein engineered mutants are included. Amylases include, for example, Δ-amylases obtained from Bacillus, e.g. a special strain of B. licheniformis, described in more detail in GB 1,296,839.

Examples of useful amylases are the variants described in WO 94/02597, WO 94/18314, WO 96/23873, and WO 97/43424, especially the variants with substitutions in one or more of the following positions: 15, 23, 105, 106, 124, 128, 133, 154, 156, 181, 188, 190,197, 202, 208, 209, 243, 264, 304, 305, 391, 408, and 444.

Commercially available amylases are Duramyl□, Termamyl□, Fungamyl□ and BAN□ (Novozymes A/S), Rapidase□ and Purastar□ (Genencor International Inc.).

Cellulases:

Suitable cellulases include those of bacterial or fungal origin. Chemically modified or protein engineered mutants are included. Suitable cellulases include cellulases from the genera Bacillus, Pseudomonas, Humicola, Fusarium, Thielavia, Acremonium, e.g. the fungal cellulases produced from Humicola insolens, Myceliophthora thermophila and Fusarium oxysporum disclosed in U.S. Pat. No. 4,435,307, No. 5,648,263, No. 5,691,178, No. 5,776,757 and WO 89/09259.

Especially suitable cellulases are the alkaline or neutral cellulases having colour care benefits. Examples of such cellulases are cellulases described in EP 0 495 257, EP 0 531 372, WO 96/11262, WO 96/29397, WO 98/08940. Other examples are cellulase variants such as those described in WO 94/07998, EP 0 531 315, U.S. Pat. No. 5,457,046, No. 5,686,593, No. 5,763,254, WO 95/24471, WO 98/12307 and PCT/DK98/00299.

Commercially available cellulases include Celluzyme™, and Carezyme™ (Novozymes A/S), Clazinase™, and Puradax HA™ (Genencor International Inc.), and KAC-500(B) ™ (Kao Corporation).

Peroxidases/Oxidases:

Suitable peroxidases/oxidases include those of plant, bacterial or fungal origin. Chemically modified or protein engineered mutants are included. Examples of useful peroxidases include peroxidases from Coprinus, e.g. from C. cinereus, and variants thereof as those described in WO 93/24618, WO 95/10602, and WO 98/15257.

The detergent may be a liquid detergent, and the liquid detergent may be aqueous (typically containing up to 70% water and 0-30% organic solvent) or non-aqueous.

The detergent may contain 0-65% of a detergent builder or complexing agent such as zeolite, diphosphate, triphosphate, phosphonate, carbonate, citrate, nitrilotriacetic acid, ethylenediaminetetraacetic acid, diethylenetriaminepentaacetic acid, alkyl- or alkenylsuccinic acid, soluble silicates or layered silicates (e.g. SKS-6 from Hoechst).

The detergent may comprise one or more polymers. Examples are carboxymethylcellulose, poly(vinylpyrrolidone), poly (ethylene glycol), poly(vinyl alcohol), poly(vinylpyridine-N-oxide), poly(vinylimidazole), polycarboxylates such as polyacrylates, maleic/acrylic acid copolymers and lauryl methacrylate/acrylic acid copolymers.

The detergent may contain a bleaching system, which may comprise a H₂O₂ source, such as perborate or percarbonate which may be combined with a peracid-forming bleach activator such as tetraacetylethylenediamine or nonanoyloxybenzenesulfonate. Alternatively, the bleaching system may comprise peroxyacids of e.g. the amide, imide, or sulfone type.

The enzyme(s) of the detergent composition may be stabilized using conventional stabilizing agents, e.g., a polyol such as propylene glycol or glycerol, a sugar or sugar alcohol, lactic acid, boric acid, or a boric acid derivative, e.g., an aromatic borate ester, or a phenyl boronic acid derivative such as 4-formylphenyl boronic acid.

The detergent may also contain other conventional detergent ingredients such as e.g. fabric conditioners including foam boosters, suds suppressors, anti-corrosion agents, soil-suspending agents, anti-soil redeposition agents, dyes, bactericides, optical brighteners, hydrotropes, tarnish inhibitors, or perfumes.

It is at present contemplated that in the detergent composition any enzyme, in particular enzymes encapsulated in the polymer-based vesicles, may be added in an amount corresponding to 0.01-100 mg of enzyme protein per liter of wash liquor, preferably 0.05-10 mg of enzyme protein per liter of wash liquor, more preferably 0.1-5 mg of enzyme protein per liter of wash liquor, and most preferably 0.1-1 mg of enzyme protein per liter of wash liquor.

Methods

The method of the invention may be used for protection of a compound in a surfactant solution, such as separation of incompatible compounds. Incompatibility between compounds may result in reduced storage stability, reduced shelf life, and degradation. In the case of biologically active compounds, incompatibility between compounds may result in loss of biological activity—e.g. enzymes may loose their enzymatic activity.

The method of the invention may also be used advantageously for controlled release of the encapsulated compound. When the composition with the vesicle is diluted, osmotic swelling will eventually result in the rupture of the vesicle, and the encapsulated compound will be released into the solution. However, the vesicle may also be ruptured by a mechanical treatment, such as being squeezed through a suitable filter.

The present invention is further described by the following examples which should not be construed as limiting the scope of the invention.

### EXAMPLES

Chemicals used as buffers and substrates were commercial products of at least reagent grade.

A suspension of vesicles of a standard phospholipid, DMPC (dimyristoylphosphatidylcholine, HPLC grade from Avanti Polar Lipids), was compared with suspensions of vesicles of various amphiphilic polymers (e.g. described above in “Synthetic polymers”) with respect to the ability to retain activity of an enzyme initially encapsulated in the vesicles. A control solution of the buffer containing the substance intended for encapsulation was treated as the amphiphile suspensions.

### Example 1

Encapsulation in Vesicles of Polymers and Phospholipids

A total of 0.5%(w/w) of each the following amphiphiles (B, C and D are available from Risoe National Laboratory, Denmark):

A) 0.5% DMPC,

B) 0.5% PEO-40-PEE-37,

C) 0.45:0.05% PEO-40-PEE-37/PEO-50-PEE-37, and

D) 0.45:0.05%W PEO-40-PEE-37/PEO-40-PEE-74-PEO-40

were separately suspended at 70 degrees Celsius in a buffer (100 mM sucrose and 10 mM Tris, pH 7.3) containing the substance intended for encapsulation, in this example 1 mg/ml alpha-amylase from Bacillus licheniformis (available as Termamyl® from Novozymes A/S, Denmark).

The suspensions were vigorously mixed in an ultrasound bath at 70 degrees Celsius for 30 minutes. Vesicles were produced according to the manufactures specifications in a T.001 10 ml thermo-barrel Extruder from NORTHERN LIPIDS INC., Vancouver BC, Canada. The suspensions were initially passed three times through 400 nm filter; hereafter five times through 200 nm filters. Operation pressure was 5-10 atmospheres at 50 degrees Celsius.

### Example 2

Enrichment of the Encapsulated Substance

The extruded vesicles were places in dialysis tubes (with a molecular cut-off of 100 kDa, product number 235071 from Spectra). Buffer without the substance intended for encapsulation was used as exterior medium. The concentrated vesicle suspensions were analyzed by differential scanning calorimetry to ascertain the properties of the vesicles and the amount of encapsulated enzyme. The encapsulated amylase was also quantified according to a standard alpha-amylase assay (the Phadebas method).

### Example 3

Evaluation of the Quality of the Encapsulating Structure

The suspensions containing the enriched encapsulated substance, and the control solution, are added separately to solutions containing from 0.1%(w/w) to 10%(w/w) of various mixtures of linear alkylbenzenesulphonate (Marion AS3 obtainable from Huls) and alcohol ethoxylate (Neodol 25-7 obtainable from Shell Chemicals), ranging from exclusively linear alkylbenzenesulphonate to exclusively alcohol ethoxylate.

After from 1 day to 4 weeks of incubation at room temperature, Bacillus Lentus subtilisin 309 protease (available as Savinase® from Novozymes A/S, Denmark) is added and the samples are incubated for another 24 hours. This is done to degrade (inactivate) the amylase released from the vesicles which have been degraded during the incubation period.

The samples are now heated to 100 degrees Celsius for 10 seconds to stop the proteolytic activity and to release all remaining amylase activity from the intact vesicles. Full removal of protease activity is confirmed by a standard protease assay. The samples are then transferred to the amylase assay described above for evaluation of the residual amount of encapsulated amylase in the vesicles.

From the results it is seen that the vesicles composed of amphiphiles B, C and D (see Example 1) are more stable in a solution containing high concentrations of surfactant compared to traditional vesicles composed of DMPC. A higher amount of active amylase is retained after storage when the vesicles are composed of amphiphiles B, C and D than when the vesicles are composed of DMPC (amphiphile A in Example 1).

1. A composition comprising an enzyme encapsulated in a vesicle, wherein the vesicle comprises at least 50% of a synthetic polymer as a vesicle forming agent.

2. A composition comprising a surfactant and at least one compound encapsulated in a vesicle, wherein the vesicle comprises at least 50% of a synthetic polymer as a vesicle forming agent.

3. The composition of claim 2, wherein the compound is an enzyme.

4. The composition of claim 2, wherein the composition is a detergent.

5. A method comprising the steps of:
(a) encapsulating at least one compound in a vesicle, and
(b) adding the vesicle to a surfactant containing composition,
wherein the vesicle comprises at least 50% of a synthetic polymer as a vesicle forming agent.

6. A method for preventing a compound from reacting with other compounds, comprising encapsulating the compound in a vesicle, wherein the vesicle comprises at least 50% of a synthetic polymer as a vesicle forming agent.

7. The method of claim 5 or 6, wherein the compound is an enzyme

8. A method for improving the stability of an enzyme, comprising encapsulating the enzyme in a vesicle, wherein the vesicle comprises at least 50% of a synthetic polymer as a vesicle forming agent.

9. A method of preventing an enzyme from reacting with other compounds, comprising encapsulating the enzyme in a vesicle, wherein the vesicle comprises at least 50% of a synthetic polymer as a vesicle forming agent.
